(19) United States
(12) Patent Application Publication
(10) Pub. No.: US 2012/0298156 A1
(43) Pub. Date: Nov. 29, 2012

(54) Automatic Cleaning Device for a Liquid Container

(76) Inventors: Heng-Yuan LIU, Yangmei City (TW); Yi-Rong PENG, Yangmei City (TW)

(21) Appl. No.: 13/114,089

(22) Filed: May 24, 2011

(51) Int. Cl. B08B 9/093

(52) U.S. Cl. 134/56 R

(57) ABSTRACT

An automatic cleaning device includes a cleaning tube having a longitudinal hole extending along a longitudinal axis. A connecting tube extends from a bottom of an intermediate section of the cleaning tube and is rotatably received in a draining tube in a bottom of a liquid container. Left and right guiding openings are defined in bottoms of left and right sections of the cleaning tube and extend slantingly from an outer periphery through an inner periphery of the cleaning tube. Each guiding opening includes a central axis spaced from the longitudinal axis. The left and right guiding openings have opposite extending directions. Siphon effect is created when a liquid in the liquid container is being drained via the draining tube. The liquid imparts force to inner peripheral walls of the guiding openings, causing the cleaning tube and the connecting tube to rotate about a central axis of the connecting tube.

### BACKGROUND OF THE INVENTION

The present invention relates to an automatic cleaning device for a liquid container and, more particularly, to a cleaning device mounted in a liquid container and capable of automatically cleaning the liquid container.

Containers for receiving liquids, such as water tanks, cooling towers, filtering tanks, and chemical receiving tanks, are frequently used in daily lives and working sites. After a period of time, the impurities in the liquids are liable to accumulate in the containers. Periodical cleaning of the containers is, thus, required. In an example of cleaning a container receiving water, a worker enters the container or cleans an inner face of the container with a cleaning tool. The water in the container is drained after cleaning.

However, the impurities in the container will stick back to the inner face of the container while draining the water. The worker has to clean the inner face again, wasting time and resources and resulting in increased costs for cleaning.

Thus, a need exists for a novel liquid container cleaning device without the above disadvantages.

### BRIEF SUMMARY OF THE INVENTION

The primary objective of the present invention is to provide an automatic cleaning device for cleaning an inner face of a liquid container to reduce the liquid wasted during cleaning without the need of workers and electricity, reducing the expenses and costs for cleaning.

An automatic cleaning device according to the present invention is adapted to be mounted in a lower portion of the liquid container. The liquid container includes a bottom. A draining tube has an upper end located in the bottom of the liquid container. The liquid container is adapted to receive a liquid that is drainable through the draining tube. The automatic cleaning device includes a cleaning tube having a longitudinal hole extending along a longitudinal axis. The cleaning tube includes an intermediate section. A connecting tube extends from a bottom of the intermediate section of the cleaning tube in a radial direction perpendicular to the longitudinal axis and is in communication with the longitudinal hole of the cleaning tube. The cleaning tube further includes left and right sections on opposite sides of the connecting tube. The connecting tube is adapted to be rotatably received in the upper end of the draining tube. A first, left guiding opening is defined in a bottom of the left section. The first, left guiding opening extends slantingly from an outer periphery of the cleaning tube through an inner periphery of the cleaning tube and is in communication with the longitudinal hole of the cleaning tube. The first, left guiding opening includes a central axis spaced from the longitudinal axis of the cleaning tube in a radial direction perpendicular to the longitudinal axis. A first, right guiding opening is defined in a bottom of the right section. The first, right guiding opening extends slantingly from the outer periphery through the inner periphery of the cleaning tube and is in communication with the longitudinal hole of the cleaning tube. The first, right guiding opening includes a central axis spaced from the longitudinal axis of the cleaning tube in a radial direction perpendicular to the longitudinal axis. The first, right guiding opening has an extending direction opposite to that of the first, left guiding opening. Siphon effect is created when the liquid is being drained out of the liquid container via the draining tube. The liquid flows through the first, left guiding opening and the first, right guiding opening into the cleaning tube and flows through the connecting tube and is drained via the draining tube. Soils in the liquid container are drained along with the liquid flowing through the cleaning tube, the connecting tube, and the draining tube. The liquid imparts force to an inner peripheral wall of the first, left guiding opening and an inner peripheral wall of the first, right guiding opening. Rotational force in the same direction is imparted to the left and right sections, causing the cleaning tube and the connecting tube to rotate about a central axis of the connecting tube.

Preferably, the left section of the cleaning tube further includes a plurality of second, left guiding openings defined in the bottom of the left section and spaced along the longitudinal axis. Each of the plurality of second, left guiding openings extends slantingly from the outer periphery of the cleaning tube through the inner periphery of the cleaning tube and is in communication with the longitudinal hole of the cleaning tube. Each of the plurality of second, left guiding openings includes a central axis spaced from the longitudinal axis of the cleaning tube in a radial direction perpendicular to the longitudinal axis. The right section of the cleaning tube further includes a plurality of second, right guiding openings defined in the bottom of the right section and spaced along the longitudinal axis. Each of the plurality of second, right guiding openings extends slantingly from the outer periphery through the inner periphery of the cleaning tube and is in communication with the longitudinal hole of the cleaning tube. Each of the plurality of second, right guiding openings includes a central axis spaced from the longitudinal axis of the cleaning tube in a radial direction perpendicular to the longitudinal axis. Each of the plurality of second, right guiding openings has an extending direction opposite to that of each of the plurality of second, left guiding openings.

Preferably, each of the first and second left guiding openings has rectangular cross sections. Each of the first and second right guiding openings has rectangular cross sections. The liquid imparts force to an inner peripheral wall of each of the plurality of second, left guiding openings and an inner peripheral wall of each of the plurality of second, right guiding openings. The liquid flows through the first and second, left guiding openings and the first and second, right guiding openings into the cleaning tube and flows through the connecting tube and is drained via draining tube, increasing the rotational force imparted to the left and right sections.

Preferably, each of the left and right sections of the cleaning tube includes a plurality of bristles extending downward from the bottoms of the left and right sections.

Preferably, a guiding member is mounted in the connecting tube and includes a plurality of arcuate guiding grooves on an outer periphery thereof. The plurality of arcuate guiding grooves is spaced in a circumferential direction about the central axis of the connecting tube.

Preferably, a guiding member is mounted in the draining tube and includes a plurality of arcuate guiding grooves on an outer periphery thereof. The plurality of arcuate guiding grooves is spaced in a circumferential direction about the central axis of the draining tube.

The present invention will become clearer in light of the following detailed description of illustrative embodiments of this invention described in connection with the drawings.

### DESCRIPTION OF THE DRAWINGS

FIG. 1 shows a perspective view of an automatic cleaning device according to the present invention.

FIG. 2 shows a cross sectional view of the automatic cleaning device of FIG. 1.

FIG. 3 shows a cross sectional view of the automatic cleaning device of FIG. 1 according to section line 3-3 of FIG. 2.

FIG. 4 shows a cross sectional view of the automatic cleaning device of FIG. 1 according to section line 4-4 of FIG. 2.

FIG. 5 shows a cross sectional view of a liquid container in which the automatic cleaning device of FIG. 1 is mounted.

FIG. 6 shows a view similar to FIG. 5, illustrating operation of the automatic cleaning device.

FIG. 7 shows a modified example of the automatic cleaning device according to the present invention.

FIG. 8 shows a perspective view of a guiding member of the automatic cleaning device according to the present invention.

### DETAILED DESCRIPTION OF THE INVENTION

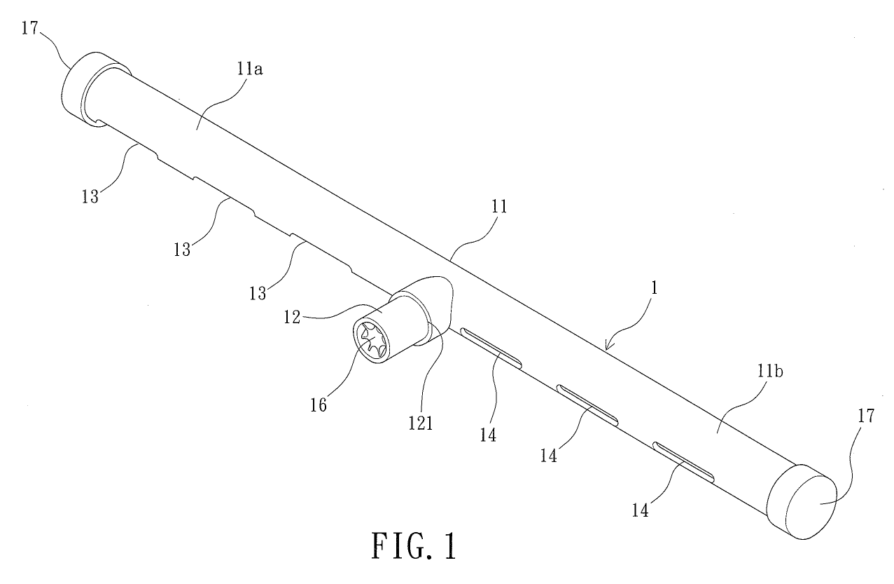

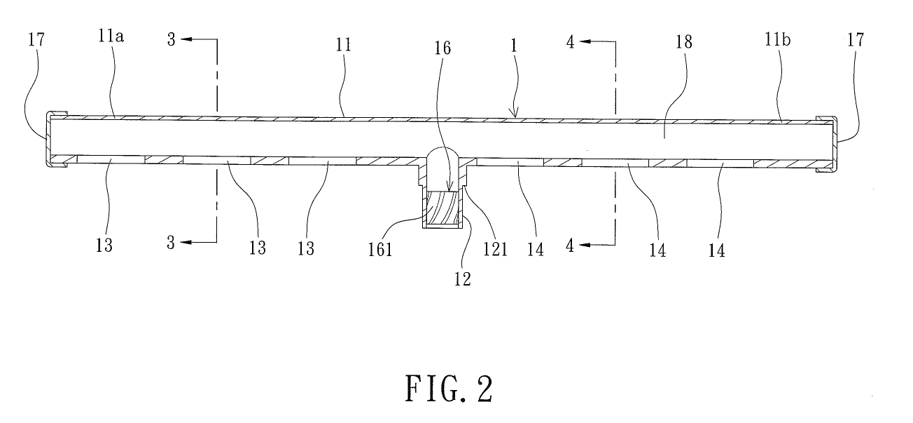

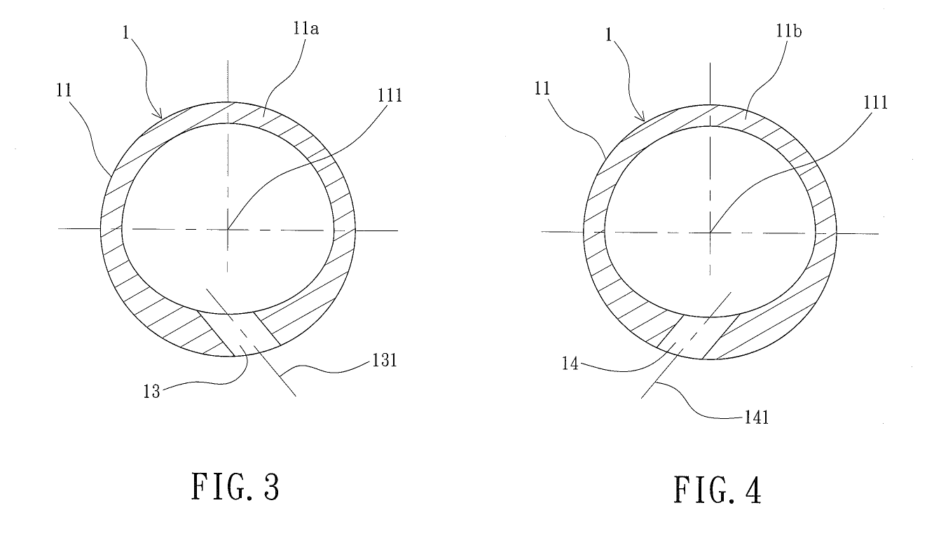

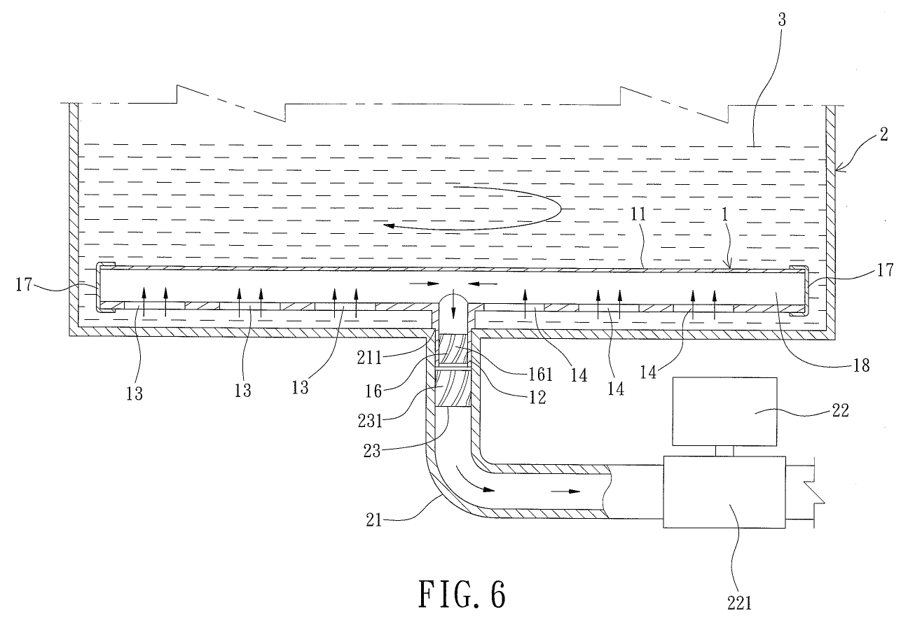

With reference to FIGS. 1-6, an automatic cleaning device according to the present invention is mounted in a lower portion of a liquid container 2 for automatically cleaning an interior of the liquid container 2 through siphon effect. In the form shown, the automatic cleaning device includes a hollow cleaning tube 1 having a tubular body 11 with a longitudinal hole 18 extending along a longitudinal axis 111. An end cap 17 is mounted to each of two ends of the cleaning tube 1. A connecting tube 12 extends from a bottom of an intermediate section of the cleaning tube 1 in a radial direction perpendicular to the longitudinal axis and is in communication with the longitudinal hole 18. The connecting tube 12 includes a shoulder 121. The connecting tube 12 is rotatably received in an upper end 211 of a draining tube 21 located at a bottom of the liquid container 2. The cleaning tube 1 further includes left and right sections 11a and 11b on opposite sides of the connecting tube 12 and spaced along the longitudinal axis 111. A plurality of left guiding openings 13 is defined in a bottom of the left section 11a. Each left guiding opening 13 extends slantingly from an outer periphery of the cleaning tube 12 through an inner periphery of the cleaning tube 12 and is in communication with the longitudinal hole 18, providing a deeper opening. A central axis 131 of each left guiding opening 13 is spaced from the longitudinal axis 111 in a radial direction perpendicular to the longitudinal axis 111. The left guiding openings 13 can have different slopes or different lengths to provide different sucking forces at the left guiding openings 13. A plurality of right guiding openings 14 is defined in a bottom of the right section 11b. Each right guiding opening 14 extends slantingly from the outer periphery through the inner periphery of the cleaning tube 12 and is in communication with the longitudinal hole 18, providing a deeper opening. A central axis 141 of each right guiding opening 14 is spaced from the longitudinal axis 111 in a radial direction perpendicular to the longitudinal axis 111. The right guiding openings 14 can have different slopes or different lengths to provide different sucking forces at the right guiding openings 14. The extending direction of each right guiding opening 14 is opposite to that of each left guiding opening 13, as shown in FIGS. 3 and 4. Each of the left and right openings 13 and 14 has rectangular cross sections in the form shown. It can be appreciated that the cleaning tube 1 can include only one left guiding opening 13 and only one right guiding opening 14.

With reference to FIGS. 1-6, when mounting the cleaning tube 1 in the liquid container 2, the connecting tube 12 is inserted into the draining tube 21, and the shoulder 121 abuts an end face of the upper end 211 of the draining tube 21. When a port 221 of a control valve 22 (such as an electromagnetic valve) mounted in the draining tube 21 is opened, the liquid 3 received in the liquid container 2 can not directly drain from the draining tube 21 due to provision of the cleaning tube 1. Nevertheless, liquid 3 flows through the left and right guiding openings 13 and 14 into the longitudinal hole 18 of the cleaning tube 1 and is drained through the connecting tube 21 and the draining tube 21. When the liquid 3 flows into the cleaning tube 1, siphoning forces are created in the left and right guiding openings 13 and 14, carrying away soils on the inner face of the liquid container 2. Thus, the inner face of the liquid container 2 is cleaned, because the soils flow out of the liquid container 2 together with the liquid 3.

When the liquid 3 flows through the left and right guiding openings 13 and 14 into the cleaning tube 1, the liquid 3 imparts force on the inner peripheral walls of the slant left and right guiding openings 13 and 14 that extend in opposite directions. Specifically, rotational force in the same direction is imparted to the left and right sections 11a and 11b. Thus, the cleaning tube 1 and the connecting tube 12 rotate about a central axis of the connecting tube 12 coaxial to a central axis of the draining tube 21. The soils on the inner face of the liquid container 2 can be cleaned by the flow of the liquid 3 through the left and right guiding openings 13 and 14 while the liquid 3 creates rotational force in the cleaning tube 1. Since the soils are carried out of the liquid container 2 by the liquid 3, re-sticking of the soils to the inner face of the liquid container 2 is avoided, effectively reducing the amount of liquid 3 wasted during cleaning of the liquid container 2. Furthermore, no workers and electricity are required.

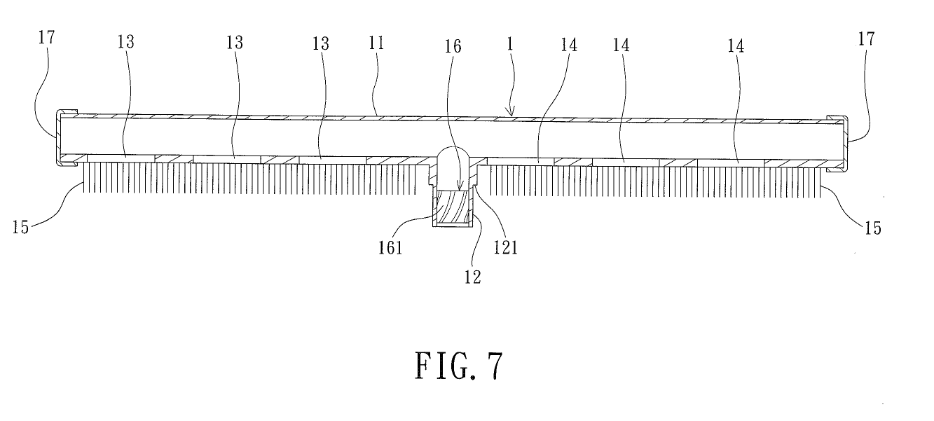

With reference to FIG. 7, each of the left and right sections 11a and 11b of the tubular body 11 of the cleaning tube 1 can include a plurality of bristles 15 extending downward from the bottom of the tubular body 11. The bristles 15 are arranged along the longitudinal axis 111. Thus, when the cleaning tube 1 and the connecting tube 12 rotate, the bristles 15 clean the inner face of the liquid container 2. Thus, the soils can be easily detached from the inner face of the liquid container 2 and flow out of the liquid container 2 together with the liquid 3.

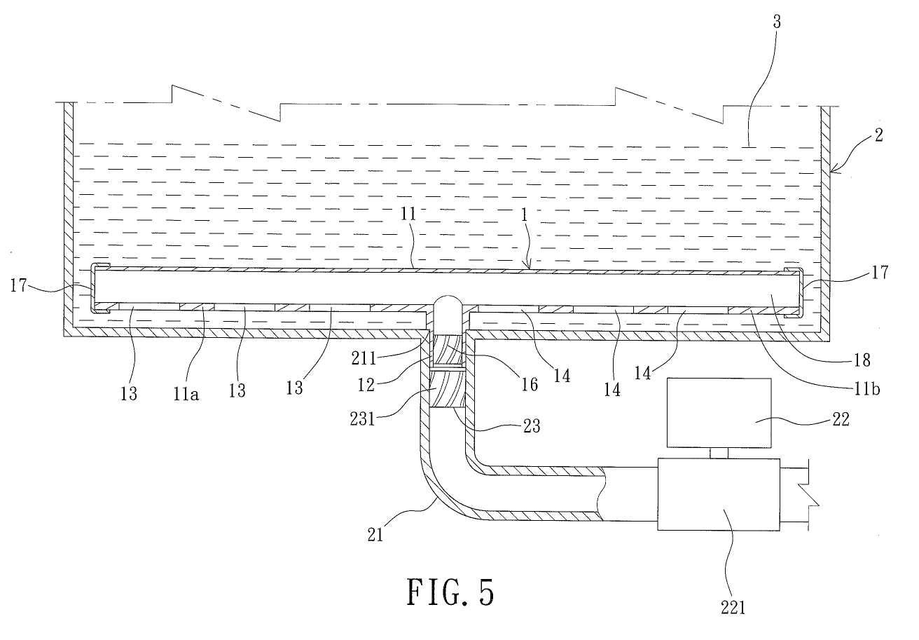

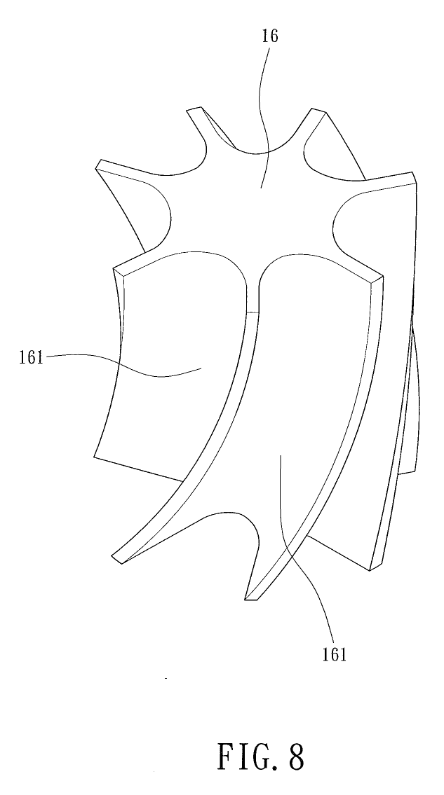

With reference to FIGS. 5, 6, and 8, a guiding member 16 can be mounted in the connecting tube 12. The guiding member 16 includes a plurality of arcuate or helical guiding grooves 161 on an outer periphery thereof. The guiding grooves 161 are spaced in a circumferential direction about the central axis of the connecting tube 12. Likewise, a guiding member 23 can be mounted in the draining tube 21. The guiding member 23 includes a plurality of arcuate or helical guiding grooves 231 on an outer periphery thereof. The guiding grooves 231 are spaced in a circumferential direction about the central axis of the draining tube 21. The rotational force is enhanced when the liquid 3 flows through the guiding grooves 161 and 231. Thus, the cleaning tube 1 and the connecting tube 12 can rotate more easily.

In view of the foregoing, the automatic cleaning device according to the present invention can automatically clean the inner face of the liquid container 2 by siphon effect. The amount of waste liquid 3 is reduced, and the liquid container 2 is cleaned without using workers and electricity, cutting the costs and expense for cleaning.

Although specific embodiments have been illustrated and described, numerous modifications and variations are still possible without departing from the essence of the invention. The scope of the invention is limited by the accompanying claims.

1. An automatic cleaning device for a liquid container, with the automatic cleaning device adapted to be mounted in a lower portion of the liquid container, with the liquid container including a bottom, with a draining tube having an upper end located in the bottom of the liquid container, with the liquid container adapted to receive a liquid, with the liquid drainable through the draining tube, with the automatic cleaning device comprising:
a cleaning tube including a longitudinal hole extending along a longitudinal axis, with the cleaning tube including an intermediate section, with a connecting tube extending from a bottom of the intermediate section of the cleaning tube in a radial direction perpendicular to the longitudinal axis and in communication with the longitudinal hole of the cleaning tube, with the cleaning tube further including left and right sections on opposite sides of the connecting tube, with the connecting tube adapted to be rotatably received in the upper end of the draining tube, with a first, left guiding opening defined in a bottom of the left section, with the first, left guiding opening extending slantingly from an outer periphery of the cleaning tube through an inner periphery of the cleaning tube and in communication with the longitudinal hole of the cleaning tube, with the first, left guiding opening including a central axis spaced from the longitudinal axis of the cleaning tube in a radial direction perpendicular to the longitudinal axis, with a first, right guiding opening defined in a bottom of the right section, with the first, right guiding opening extending slantingly from the outer periphery through the inner periphery of the cleaning tube and in communication with the longitudinal hole of the cleaning tube, with the first, right guiding opening including a central axis spaced from the longitudinal axis of the cleaning tube in a radial direction perpendicular to the longitudinal axis, with the first, right guiding opening having an extending direction opposite to that of the first, left guiding opening, with siphon effect being created when the liquid is being drained out of the liquid container via the draining tube, with the liquid flowing through the first, left guiding opening and the first, right guiding opening into the cleaning tube and flowing through the connecting tube and drained via the draining tube, soils in the liquid container drained along with the liquid flowing through the cleaning tube, the connecting tube, and the draining tube, with the liquid imparting force to an inner peripheral wall of the first, left guiding opening and an inner peripheral wall of the first, right guiding opening, with rotational force in a same direction imparted to the left and right sections, causing the cleaning tube and the connecting tube to rotate about a central axis of the connecting tube.

2. The automatic cleaning device for a liquid container as claimed in claim 1, with the left section of the cleaning tube further including a plurality of second, left guiding openings defined in the bottom of the left section and spaced along the longitudinal axis, with each of the plurality of second, left guiding openings extending slantingly from the outer periphery of the cleaning tube through the inner periphery of the cleaning tube and in communication with the longitudinal hole of the cleaning tube, with each of the plurality of second, left guiding openings including a central axis spaced from the longitudinal axis of the cleaning tube in a radial direction perpendicular to the longitudinal axis, with the right section of the cleaning tube further including a plurality of second, right guiding openings defined in the bottom of the right section and spaced along the longitudinal axis, with each of the plurality of second, right guiding openings extending slantingly from the outer periphery through the inner periphery of the cleaning tube and in communication with the longitudinal hole of the cleaning tube, with each of the plurality of second, right guiding openings including a central axis spaced from the longitudinal axis of the cleaning tube in a radial direction perpendicular to the longitudinal axis, with each of the plurality of second, right guiding openings having an extending direction opposite to that of each of the plurality of second, left guiding openings.

3. The automatic cleaning device for a liquid container as claimed in claim 2, with each of the first and second left guiding openings having rectangular cross sections, with each of the first and second right guiding openings having rectangular cross sections, with the liquid imparting force to an inner peripheral wall of each of the plurality of second, left guiding openings and an inner peripheral wall of each of the plurality of second, right guiding openings, with the liquid flowing through the first and second, left guiding openings and the first and second, right guiding openings into the cleaning tube and flowing through the connecting tube and drained via the draining tube, increasing the rotational force imparted to the left and right sections.

4. The automatic cleaning device for a liquid container as claimed in claim 1, with each of the left and right sections of the cleaning tube including a plurality of bristles extending downward from the bottoms of the left and right sections.

5. The automatic cleaning device for a liquid container as claimed in claim 1, further comprising: a guiding member be mounted in the connecting tube, with the guiding member including a plurality of arcuate guiding grooves on an outer periphery thereof, with the plurality of arcuate guiding grooves spaced in a circumferential direction about the central axis of the connecting tube.

6. The automatic cleaning device for a liquid container as claimed in claim 1, further comprising: a guiding member mounted in the draining tube, with the guiding member including a plurality of arcuate guiding grooves on an outer periphery thereof, with the plurality of arcuate guiding grooves spaced in a circumferential direction about the central axis of the draining tube.
